(19) United States
(12) Patent Application Publication
(10) Pub. No.: US 2026/0286714 A1
(43) Pub. Date: Sep. 24, 2026

(54) LARGE FORMAT SYNCHRONIZED EMBOSSING PROCESS

(71) Applicant: Kronoplus Limited, Mosta, MST (MT)

(72) Inventor: Mark Bircham, Rosenheim (DE)

(73) Assignee: Kronoplus Limited, Mosta, MST (MT)

(21) Appl. No.: 19/474,310

(22) PCT Filed: Apr. 14, 2023
(86) PCT No.: PCT/EP2023/059822

§ 371 Date: Oct. 10, 2025

(51) Int. Cl. E04F 13/10; B31F 1/07

(52) U.S. Cl. CPC E04F 13/105; B31F 1/07; B31F 2201/0756; B31F 2201/0761; B31F 2201/0792

(57) ABSTRACT

A method for manufacturing a panel, in particular a wall, ceiling, furniture or flooring panel, by means of a synchronized embossing process, the method comprising the following steps: providing a carrier plate; providing a decorative paper with a decorative pattern; and providing pressing means having an embossing structure; wherein the decorative paper with the decorative pattern and/or the pressing means having the embossing structure were made taking into account a dimensional expansion of the decorative paper and/or of the pressing means during the manufacturing of a panel.

### 1. TECHNICAL FIELD

The present invention relates to a method for the manufacture of a panel, in particular a laminate, wall, ceiling, furniture or flooring panel. The present invention further relates to a correspondingly manufactured panel and laminate.

### 2. PRIOR ART

Presently a wide range of materials exist that can be used in the production of panels, such as wall, ceiling, furniture, and flooring panels. Furthermore, a wide range of manufacturing methods for panels exist. Such panels comprise various different properties. Exemplarily, these properties include environmental friendliness such as recyclability, feel, appearance, and/or durability such as fire, moisture, and/or scratch resistance.

Particularly in the field of panels with visible surfaces, which include contact surfaces, there is an ongoing need to improve the properties of the panels and/or the corresponding manufacturing methods: The manufacturing methods should provide for optically attractive panels, panels with improved haptic appearance and panels which are also durable at the same time.

Known panels in such technical field for visible surfaces include laminate panels, which are relatively inexpensive and easy to handle. Typically, they comprise a carrier plate made from medium density fiberboard (MDF) or high-density fiberboard (HDF) material, which allows for thermal recyclability. Known methods in such technical field for visible surfaces include the application of decorative layers on the carrier plate during the manufacturing process to provide for optically attractive panels.

In current practices, decorative panels are typically provided by applying a decorative printing layer on the plate by means of rotogravure printing.

Conventional rotogravure printing methods of panels, in particular of wood-based floorings, typically employ sets of engraved cylinders so as to provide for an embossing and to engrave an image onto the wood. For this, the image is engraved onto a rotogravure cylinder before performing the embossing.

The afore-mentioned conventional methods have various disadvantages.

For instance, the printing pattern is provided repeatedly onto the panel depending on the diameter of the rotogravure cylinder used for the graving. In particular, it must be ensured that the pattern forms a continuous loop on the rotogravure cylinder to avoid discontinuous printings on the wood. This repeat in the pattern leads to an unnatural look. The diameter of the rotogravure cylinder could be increased to increase the length of the pattern without repetition. However, this increases costs.

As an example, using rotogravure cylinders with a circumference of 2100 mm and a panel width of 2070 mm, results in a maximum unique pattern of 4.31 m². When employing a rotogravure cylinder with a circumference of 1300 mm and a panel width of 2070 mm, the maximum unique pattern of 2.69 m².

Further, although the prior art attempted to bring the embossed structure of the plate in synchronization with the printing pattern, there is still a need for further improvement, as this is not satisfactorily performed thus far.

In view of the above disadvantages, it is of importance to provide improved panels and improved manufacturing methods for panels.

Thus, it is an object of the present invention to at least partially overcome the disadvantages mentioned above. Particularly, it is an object of the present invention to provide an overall attractive and visually appealing panel. The synchronization of the embossed structure and the decorative pattern should be enhanced. The panel should also have a haptically pleasant feeling. Further, a corresponding manufacturing method for such a panel is to be provided. The manufacturing method should be simplified and made cost-effective.

### 3. SUMMARY OF THE INVENTION

The objects are achieved, at least partly, by the subject-matter of the independent claims. Further aspects of the present disclosure are defined in the dependent claims.

Since the method for manufacturing a panel, the panel, the system for manufacturing a panel and the method for manufacturing pressing means for use in a synchronized embossing process all relate to panels according to the present disclosure, it will be understood that advantages and/or features described with reference to one of these may also apply to the others and vice versa even when not explicitly described.

### Method

In one aspect, the object is achieved by a method for manufacturing a panel in particular a wall, ceiling, furniture or flooring panel, by means of a synchronized embossing process, the method comprising the following steps:
providing a carrier plate;
providing a decorative paper with a decorative pattern; and
providing pressing means having an embossing structure;
wherein the decorative paper with the decorative pattern and/or the pressing means having the embossing structure were made taking into account a dimensional expansion of the decorative paper and/or of the pressing means during the manufacturing of a panel.

The method has the advantage that an improved synchronization of the decorative pattern and the embossed structure on the plate can be achieved (embossed in register). In particular, the printing is synchronized with embossing so as to provide a visually improved and attractive panel. This catches the interests of consumers. In particular, the reality is resembled in an improved manner by the panel. For instance, the decorative pattern may resemble natural wood or the like, which is, thereby, replicated in an improved manner according to the present disclosure. Usually, dimensional expansions are not taking into account, which leads to rather impaired optical results, as the embossed structure in the plate does not match the decorative pattern. The inventors found a way to overcome this disadvantage.

The “dimensional expansion” may be any kind of elongation, shrinking, swelling or the like. The dimensional expansion may occur due to variations of any kind of heat, pressure, conditions of an impregnating step or the like.

The term “taking into account” (which could mean “based on”, “considered”) is to be understood such that means may have been undertaken to at least partially compensate for said dimensional expansion. In particular, the dimensional expansion of the decorative paper and of the pressing means may be different and the inventors paved a way to find an optimum balance to match both dimensional expansions.

It is understood that during the synchronized embossing process, the pressing means and the decorative paper have already been made by taking into account said dimensional expansion of the decorative paper and/or of the pressing means. For instance, test runs may have been made to retrieve a dimensional expansion of the decorative paper during printing the decorative pattern on the decorative paper (e.g. due to swelling of the paper during impregnating or the like). This knowledge may have been used for scaling the decorative pattern accordingly so as to compensate any dimensional expansion as further described herein. It is appreciated that the provided decorative paper may already include the scaled decorative pattern when the method is employed. Further, test runs may have been made to retrieve a dimensional expansion of the embossing structure of the pressing means (e.g. by heat and/or pressure). This knowledge may have been used for scaling for instance the pressing means. It is appreciated that the provided pressing means may already have been scaled when the method is employed.

A synchronized embossing process may be understood as a process that provides texture, embossed structure or the like which follows the decorative pattern of the decorative paper, on the plate. This improves realism to achieve an appearance and texture of a natural wood, stone or the like. In this manner, it is understood that the synchronized embossing process comprises for instance applying the decorative paper on the plate whilst embossing the plate using an embossing structure for providing the plate with an embossed structure on its main surface. The embossing structure may be provided for instance by a facing press (a facing press may include press plates).

The embossed structure in the plate may have a three-dimensional shape, meaning that the embossed structure has an extension at least recognizably in three spatial directions.

Once the decorative paper is provided, it may directly be used in the synchronized embossing process. Alternatively, it may be round up to a roll and/or stored for some time before being used in the synchronized embossing process.

Preferably, the decorative paper with a decorative pattern was made by scaling, using a computer, the dimension of the decorative pattern using one or more first scaling values.

This has the advantage that the dimensional expansion of the decorative paper can be taken into account in an improved manner. For instance, data retrieved from history, e.g., tests in the past, and/or current tests may be used to improve the consideration of the dimensional expansion. This facilitates matching of the embossed structure and the decorative pattern on the plate. The one or more first scaling values may be integers or floating points. The one or more first scaling values may be stored before being applied in a non-transitory computer-readable medium, e.g., a computer memory.

As an example, an image used as the decorative pattern may be scaled using the one or more first scaling values. This may be performed by scaling the image before applying the decorative pattern on the paper for providing the decorative paper.

Preferably, the method comprises impregnating the decorative paper, wherein the one or more first scaling values are based at least in part on a dimensional expansion of the decorative paper during impregnating the decorative paper.

The swelling of the decorative paper during impregnating may be rather large. Thereby, it is beneficial to take this knowledge into account by providing the one or more first scaling values accordingly.

Preferably, the one or more first scaling values vary locally with respect to the decorative paper.

The dimensional expansion (e.g. swelling) of the decorative paper may differ depending on the location on the decorative paper. For instance, in a central portion of the decorative paper, the swelling may be larger compared to an outermost edge of the paper. Hence, it is beneficial that the one or more first scaling values also vary locally so as to allow an improved synchronization during the synchronized embossing process.

Preferably, the one or more first scaling values are selected based on a predetermined functional relationship, preferably a swelling curve, based on properties of the paper and/or conditions of impregnating.

This further aids in providing an improved synchronization. The swelling curve may be based on several properties of the paper (e.g. a grammage, a thickness or the like) and/or conditions of impregnating (e.g. the amount of resin or the like) so as to allow an enhanced synchronized embossing process. This aids in creating a more natural appearance of the panel.

Preferably, the one or more first scaling values are in the range of 0.9 to 1.1, preferably 0.95 to 1.05, more preferably 0.98 to 1.02, more preferably 0.99 to 1.01, more preferably 0.994 to 1.006, more preferably 0.996 to 1.004, most preferably 0.998 to 1.002.

The one or more first scaling values are selected so as to compensate for any dimensional expansion in an improved manner. The one or more first scaling values may also be larger or smaller, depending on the circumstances.

Preferably, the dimensions of the pressing means were selected based on one or more second scaling values, the one or more second scaling values being based at least in part on a thermal expansion of the pressing means during the synchronized embossing process.

This has the advantage that the dimensional expansion of the pressing means can be taken into account even more accurately. For instance, data retrieved from history may be used to determine the one or more second scaling values and/or it may be possible to predict the one or more second scaling values using models, such as simulation models. The vast majority of the dimensional expansion of the pressing means may be caused by increased heat. Hence, it is beneficial to us information of the thermal expansion during the synchronized embossing process in order to determine the one or more second scaling values. The pressing means is thus made in an improve manner. This facilitates an improved matching of the embossed structure and the decorative pattern on the plate.

Preferably, the one or more second scaling values comprise a length scaling value for the length of the pressing means and width scaling value for the width of the pressing means.

Scaling the length and/or the width of the pressing means may be more easily performed. For instance, when a substantially flat facing press is used, the thermal expansion in the length and width may be determined. Hence, when making the pressing means (e.g. in a cold state, when the pressing means is not in operation in the synchronized embossing process), the pressing means could be scaled in length and width in order to arrive at a new length and width in which the pressing means is to be made.

Preferably, the one or more second scaling values are in the range of 0.9 to 1.1, preferably 0.95 to 1.05, more preferably 0.98 to 1.02, more preferably 0.99 to 1.01, more preferably 0.994 to 1.006, more preferably 0.996 to 1.004, most preferably 0.998 to 1.002.

The one or more second scaling values are selected such that they can compensate for any dimensional expansion in an unprecedented manner. The one or more second scaling values may also be larger or smaller, depending on the circumstances.

Preferably, the decorative paper is provided by printing the decorative pattern on the paper, preferably by means of digital printing.

This has the advantage that the printing can be automated more easily. Further, any kind of decorative patterns may be used in a simplified manner. The digital printing may be employed by various known means. For instance, RGB/CMYK or separated data may be employed.

Preferably, the decorative pattern is provided by an image retrieved by means of photography or a scanner, preferably by an image from a natural scenery.

For instance, the image could be obtained by capturing the image via photography or by using a scanner, such as an industrial scanner. The image may be optimized using software including, but not limited to Adobe Photoshop. It is beneficial if the image is provided in a resolution of, for instance, greater than 100 dpi, 200 dpi, 300 dpi, or even greater than 400 dpi.

Preferably, the decorative pattern imitates a natural pattern, preferably a wooden surface, a stone, a tile, or the like.

This has the advantage that a more natural look can be provided. The decorative pattern may imitate any desired surface, which is appreciated by a consumer.

Preferably, the decorative pattern provided on the plate has a substantially unique pattern along at least 2 m, preferably at least 3 m, more preferably at least 4 m, more preferably at least 4.5 m, more preferably at least 5.0 m, more preferably at least 5.5 m, most preferably at least 6.0 m of the length of the plate.

This has the advantage that a rather large unique pattern in the resulting embossed decorative paper can be achieved. In the prior art, when employing rotogravure printing or the like, provision of a rather large unique pattern is limited by a diameter of the rotogravure cylinders.

A unique pattern may be understood such that it does not repeat itself.

Preferably, the carrier plate is a medium density fiber (MDF) plate, a high-density fiber (HDF) plate, a particle plate, a compact laminate plate, or a high-pressure laminate (HPL) plate.

This material can be easily obtained and has proven to be beneficial. The carrier plate (also referred to herein as “plate” for brevity) may be a board made of a wood-based material. In a further example, the plate can also be made of a plastic material, like Stone Plastic Composite (SPC), Luxury Vinyl Tile (LVT), rigid polymer core or expanded polymer core as well as mixed constructions which are widely used in the flooring industry.

Preferably, the synchronized embossing process takes place at a temperature of at least 100° C., preferably at least 140° C., more preferably at least 180° C., most preferably at least 200° C.; and/or at a temperature of at most 300° C., preferably at most 260° C., more preferably at most 240° C., most preferably at most 220° C.

The temperature should not be too large and not too small for the synchronized embossing process to function properly. Thus, an optimum balance should be struck as provided in here.

Preferably, the synchronized embossing process takes place at a pressure from 20 to 160 bar, preferably from 30 to 140 bar, further preferably from 40 to 120 bar, further preferably from 50 to 100 bar, most preferably from 60 to 90 bar.

The pressure should not be too large and not too small for the synchronized embossing process to function properly. Thus, an optimum balance should be struck as provided in here.

Preferably, the synchronized embossing process is a continuously pressed process.

Preferably, the pressing means is a facing press, a press belt, a double-belt press, a rotogravure cylinder, preferably a substantially flat facing press, for providing the plate with an embossed structure on its main surface substantially matching the decorative pattern of the decorative paper.

While it is advantageous that any pressing means may be employed according to the present disclosure, it is particularly beneficial if a facing press is used, e.g. a substantially flat facing press. This has the advantage that a larger unique pattern in the resulting embossed decorative paper can be achieved. In particular, the decorative pattern is thus not adversely affected by any limitation of a diameter of a rotogravure cylinder as it is the case in rotogravure printing. Thereby, the method and the panel described herein facilitate that, for instance, at least 4 times the size of traditional panels can be provided with a unique pattern.

Typically, such cylinders for embossing are limited in that their diameter needs to be increased if a larger unique pattern is to be achieved. Such increased diameter entails increasing costs. Thus, the facing press facilitates a more cost-effective method and panel.

Moreover, it is no longer necessary to have the appearance of the decorative pattern in a continuous loop, as the requirement of continuity of, e.g., a rotogravure cylinder becomes obsolete. Thereby, levels of realism compared to, e.g., traditionally employed rotogravure cylinders can be enhanced.

Preferably, the decorative paper is provided with a thermosetting resins, such as a phenolic resin, a melamine resin, or a formaldehyde resin, preferably a melamine resin.

Such a resin may be easily procured. Further, the quality of the decorative paper can be improved.

The method may also comprise applying a priming layer, a lacquer layer and/or a wear layer on the plate. The wear layer may be based on cast polypropylene. The lacquer layer may provide sufficient elasticity to compensate for deformation of the panel.

### Panel

A further aspect relates to a panel manufactured by the method as described herein.

As noted elsewhere herein, it is understood that substantially the same advantages and features mentioned with respect to the method for manufacturing the panel equally apply to the panel. Further, the features may be combined and/or interchangeable applied to embodiments of the panel and the method, respectively.

The manufactured panel has an improved overall appearance. In particular, the decorative effect is improved, since the decorative pattern may be provided to a relatively large extent in a unique manner on the plate. Moreover, the synchronization of the decorative pattern and the embossed structure on the plate is enhanced, which can be visually realized in the manufactured panel.

In one example, the embossed structure in the plate can be seen from the top of the plate. This is appreciated, as it aids in resembling a more natural look when viewed from the top. The panel also shows an improved quality, and also haptic benefits can be achieved. Accordingly, structural properties of the panel are enhanced.

Preferably, the panel is designed as a wall, ceiling, furniture or flooring panel, comprising coupling elements being configured for coupling to another similar panel.

Preferably, the panel has a width of at least 8 cm, preferably at least 20 cm, more preferably at least 30 cm, more preferably at least 40 cm, most preferably at least 50 cm, and/or of at most 260 cm, preferably at most 210 cm, more preferably at most 200 cm, more preferably at most 180 cm, more preferably at most 140 cm, most preferably at most 100 cm.

The width should not be too large and not too small. Thus, an optimum balance should be met as described in here.

These widths have proven to be sufficient to provide improved optical and haptic quality, while also maintaining a high level of robustness and mechanical integrity.

As generally applicable within the present disclosure, whenever reference is made to geometric properties of the panel and/or parts of the panel (e.g. a length, a width, or the like), any lower and/or upper limit of said geometric properties may be combined to a range.

Preferably, the panel has a length of at least 40 cm, preferably at least 50 cm, more preferably at least 60 cm, more preferably at least 80 cm, most preferably at least 100 cm, and/or of at most 580 cm, preferably at most 560 cm, more preferably at most 500 cm, more preferably at most 450 cm, most preferably at most 400 cm.

The length should not be too large and not too small. Thus, an optimum balance is to be met as described in here. The length may be selected independently of any decorative pattern, as said decorative pattern can be provided uniquely over a large extent along the length of the panel.

Preferably, the panel has a thickness of at least 4 mm, preferably at least 6 mm, more preferably at least 8 mm, more preferably at least 10 mm, more preferably at least 12 mm, more preferably at least 14 mm, more preferably at least 16 mm, more preferably at least 18 mm, most preferably at least 20 mm, and/or of at most 50 mm, preferably at most 40 mm, more preferably at most 35 cm, more preferably at most 30 mm, most preferably at most 25 mm.

Preferably, the printed paper applied on the plate has a thickness of at least 5 μm, preferably at least 10 μm, more preferably at least 20 μm, more preferably at least 30 μm, more preferably at least 40 μm, most preferably at least 50 μm, and/or of at most 200 μm, preferably at most 150 μm, more preferably at most 100 μm, more preferably at most 90 μm, most preferably at most 80 μm.

The thickness of the printed paper should not be too small and not too large. A larger thickness is desired to improve the printing and/or the synchronized embossing process. This may provide for robustness and/or rigidity. A smaller thickness is desired to save material. Thus, an optimum balance should be achieved as described in here.

A further aspect relates to a system for manufacturing a panel in particular a wall, ceiling, furniture or flooring panel, the system comprising:
a carrier plate;
a decorative paper with a decorative pattern; and
pressing means having an embossing structure;
wherein the pressing means are configured to perform a synchronized embossing process with the plate and the decorative paper;
wherein the paper with the decorative pattern and/or the pressing means having the embossing structure were made taking into account a dimensional expansion of the decorative paper and/or of the pressing means during the manufacturing of a panel.

A further aspect relates to a method for manufacturing pressing means for use in a synchronized embossing process according to any one of the aspects and/or embodiments described herein, the method comprising the following steps:
providing pressing means having an embossing structure;
wherein the pressing means having the embossing structure are made taking into account a dimensional expansion of a decorative paper and/or of the pressing means during the manufacturing of a panel.

As noted elsewhere herein, it is understood that substantially the same advantages and features mentioned with respect to the method for manufacturing the panel and the panel equally apply to the system for manufacturing the panel and the method for manufacturing pressing means. Further, the features may be combined and/or interchangeable applied to embodiments of the system, the method for manufacturing pressing means the panel and the method for manufacturing a panel.

### 4. BRIEF DESCRIPTION OF THE ACCOMPANYING FIGURES

In the following, preferred embodiments are described, by way of example only. Reference is made to the following accompanying figures:

FIG. 1 shows a diagram of an exemplary method according to the present disclosure.

FIG. 2 shows a panel according to an embodiment of the present disclosure in a side view.

FIG. 3 shows the embodiment of FIG. 2 in a top view.

FIG. 4 shows exemplary data of dimensional expansion of pressing means and decorative paper according to the present disclosure.

FIG. 5 shows an exemplary pressing means and an embossed plate in a hot state and in a cold state according to an embodiment of the present disclosure, as seen from the top.

### 5. DETAILED DESCRIPTION OF THE FIGURES

Subsequently, presently preferred embodiments will be outlined, primarily with reference to the above Figures. It is noted that further embodiments are certainly possible, and the below explanations are provided by way of example only, without limitation. Further, the present invention can also be used in other embodiments not explicitly disclosed hereafter. Moreover, as detailed below, the embodiments are compatible with each other, and individual features of one embodiment may also be applied to another embodiment.

Throughout the present figures and specification, the same reference numerals refer to the same elements. The figures may not be to scale, and the relative size, proportions, and depiction of elements in the figures may be exaggerated for clarity, illustration, and convenience.

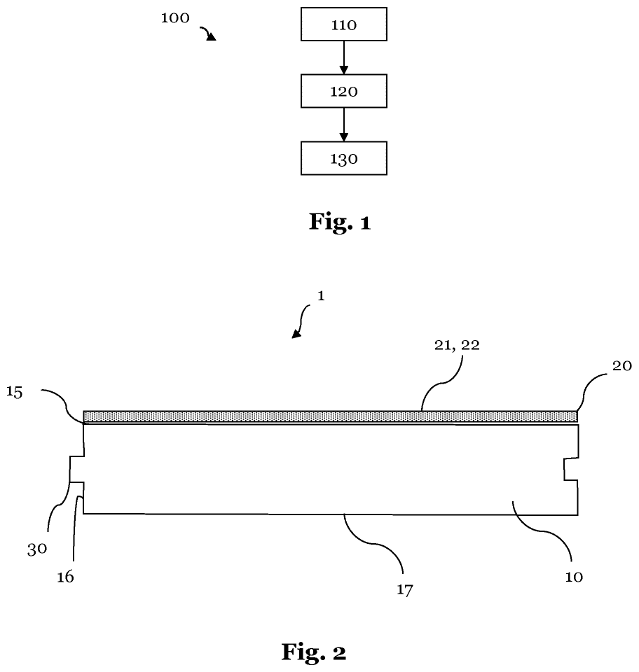

FIG. 1 shows a diagram of an exemplary method 100 for manufacturing a panel according to the present disclosure. In particular, it is shown a method 100 for manufacturing a panel 1, in particular a wall, ceiling, furniture or flooring panel, by means of a synchronized embossing process, the method 100 comprising the following steps: providing 110 a carrier plate; providing 120 a decorative paper with a decorative pattern; and providing 130 pressing means having an embossing structure; wherein the decorative paper with the decorative pattern and/or the pressing means having the embossing structure were made taking into account a dimensional expansion of the decorative paper and/or of the pressing means during the manufacturing of a panel.

The synchronized embossing process comprises embossing the plate, thereby providing embossed structures on the plate having the decorative paper applied to it. The pressing means may be a facing press.

As described herein, the method also facilitates to provide a rather large unique pattern repeat. For this purpose, a modification of alignment marks for cameras used in the impregnation process may be beneficial. For instance, marks having the shape of triangles as opposed to rectangles may be used in a center of the technical marking area. Further, it may be beneficial to add the indications such as “Front” and/or “Back” in the technical marking area. Thereby, incorrect cutting and/or pressing of the impregnated paper in the production process may be avoided.

FIG. 2 shows a panel 1 according to an embodiment of the present disclosure in a side view. The panel 1 can be a wall, ceiling, furniture, or flooring panel. The panel 1 can be a laminate. The panel 1 can be a laminate panel. The panel 1 comprises a carrier plate 10, such as a medium density fiber (MDF) carrier plate, high density fiber (HDF) carrier plate or a particle plate.

The panel 1 comprises a decorative paper 20 having a decorative pattern 21. The decorative pattern 21 may be provided by means of an image, which is printed on the paper for providing the decorative paper 20. As an example, a natural object (e.g. stone slab), which is to be reproduced, may be either photographed or digitized with an industrial scanner. The digital image may be manipulated using a computer to form a continuous loop. Further, defects may be removed, and the pattern may be optimized, and color settings may be adjusted to suit any desired effect. Depending on the format of the natural object, the pattern repeat may be typically at least 4.1 m and up to 5.6 m in length. The image may then be converted from its existing format and prepared for printing onto the paper according to the number of colors used by the industrial digital printer. As an example, an Raster Image Processor (RIP) software may be employed. The prepared image may be uploaded to a digital printer. The image may then be printed reel to reel on the paper. This may be performed continuously with many pattern repeats, which could be seamlessly connected. Thereby, an impression of an endless pattern may be provided.

The decorative paper 20 may be impregnated with a resin, such as a thermosetting resin, e.g., a phenolic resin, a melamine resin, or a formaldehyde resin, preferably a melamine resin. The decorative paper 20 and the plate 10 have an embossed structure 22, which is synchronized with the decorative pattern 21 by way of the synchronized embossing process according to the present disclosure.

The plate 10 has a top surface 15, opposite to a rear surface 17. The decorative paper 20 is applied on the top surface. Thereby, the decorative aspect of the decorative paper 20 can be recognized, which is appreciated. The rear surface 17 typically faces a ground, wall, ceiling or the like, depending on the field of application of the panel 1.

The panel 1 also comprises a connection structure 30 on at least one side surface 16 of the plate 10. The side surface 16 is substantially parallel to a thickness of the plate 10. The connection structure 30 enables that the side surface 16 is configured to be engaged with a side surface of another plate. This may be provided by profiling the plate. Profiling may also comprise providing a connection structure 30 on both side surfaces.

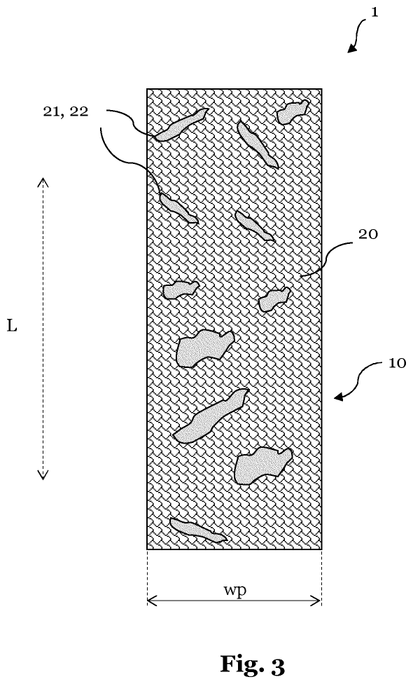

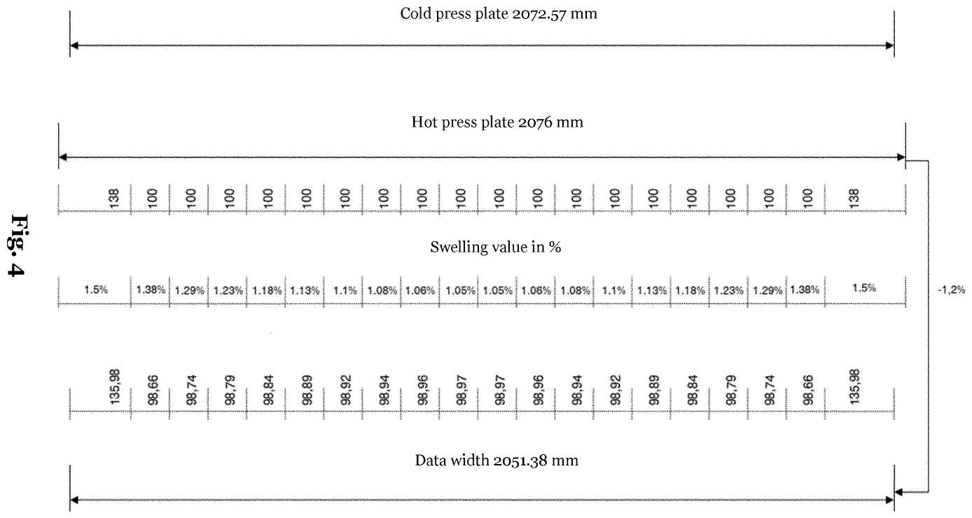

FIG. 3 shows the embodiment of FIG. 2 in a top view. Exemplarily it is indicated that the decorative pattern 21 of the decorative paper 20 are substantially synchronized with the embossed structure 22 provided on the plate 10 and the decorative paper 20 by means of a pressing means. In this figure, the width wp of the plate 10 and the length L in the longitudinal extension are also indicated.

FIG. 4 shows exemplary data of dimensional expansion of pressing means and decorative paper according to the present disclosure. The data may not be drawn to scale in this figure. The width of the press plate in a cold state (this may be the press plate of a facing press) is 2072.57 mm in this example. The width of the press plate in a hot state is 2076 mm. Further, the figure indicates swelling values of the decorative paper in %. It can be seen that the swelling values are different with respect to the location, e.g., the width. For instance, in an outer region, the swelling values are higher compared to a central region along the width. Based on these dimensional expansion a data width of the image of 2051.38 mm is indicated in this figure. A difference of (2076 mm-2051.38 mm)/2076 mm~1.2% can be derived.

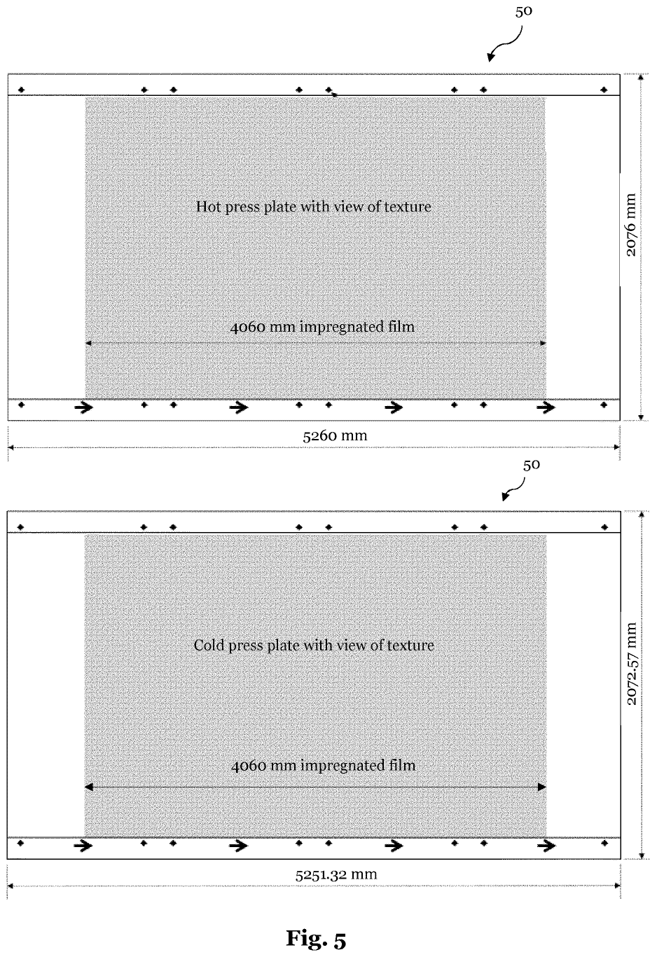

FIG. 5 shows an exemplary pressing means 50 and an embossed plate in a hot state and in a cold state according to an embodiment of the present disclosure. A length of 5260 mm and a width of 2076 mm is shown in the hot state (pressing means 50 in the upper part of the figure). The impregnated film has a length of 4060 mm. A length of 5251.32 mm and a width of 2072.57 mm is shown in the cold state (pressing means 50 in the lower part of the figure). Based on this data, a factor of 5251.32 mm/5260 mm=0.99835 may be derived to calculate the length of the cold pressing means 50 based a given length of the hot pressing means 50.

Generally, the method described herein may employ digital printing, which is often considered in the prior art as a mere technology to provide test samples. At later stages of the product development process performed by the prior art, typically rotogravure printing technologies are performed, not taking into account any dimensional expansion. Thereby, decorative patterns are often kept on a limited scale due to this. In view of the present disclosure, the inventors found a way to take into account dimensional expansion whilst performing digital printing and embossing in a synchronized embossing process.

It is noted that the above examples may be combined with further aspects as described herein and details of the examples may also be omitted, as will be understood by the skilled person. The scope of protection is determined by the claims and is not limited by the embodiments disclosed in the above figures.

It will be apparent to those skilled in the art that numerous modifications and variations of the described examples and embodiments are possible in light of the above teaching. The disclosed examples and embodiments are presented for purposes of illustration only. Other embodiments may include some or all of the features disclosed herein. Therefore, it is the intent to cover all such modifications and alternate embodiments as may come within the true scope of this invention.

### 6. LIST OF REFERENCE SIGNS

| | |
|---|---|
| 1 | panel |
| 10 | carrier plate |
| 15 | top surface |
| 16 | side surface |
| 17 | rear surface |
| 20 | decorative paper |
| 21 | decorative pattern |
| 22 | embossed structure |
| 30 | connection structure/coupling elements |
| 50 | pressing means |
| L | longitudinal extension of the plate |
| wp | width of the plate |
| 100 | method for manufacturing a panel |
| 110 | providing a carrier plate |
| 120 | providing a decorative paper |
| 130 | providing pressing means |
| 200 | method for manufacturing a pressing means |
| 1000 | system for manufacturing a panel |

1. A method for manufacturing a panel, in particular a wall, ceiling, furniture or flooring panel, by means of a synchronized embossing process, the method comprising the following steps:
providing a carrier plate;
providing a decorative paper with a decorative pattern; and
providing pressing means having an embossing structure;
wherein the decorative paper with the decorative pattern and/or the pressing means having the embossing structure were made taking into account a dimensional expansion of the decorative paper and/or of the pressing means during the manufacturing of a panel.

2. The method according to claim 1, wherein the decorative paper with a decorative pattern was made by scaling, using a computer, the dimension of the decorative pattern using one or more first scaling values.

3. The method according to claim 2, wherein the method comprises impregnating the decorative paper, wherein the one or more first scaling values are based at least in part on a dimensional expansion of the decorative paper during impregnating the decorative paper.

4. The method according to claim 2, wherein the one or more first scaling values vary locally with respect to the paper.

5. The method according to claim 2, wherein the one or more first scaling values are selected based on a predetermined functional relationship, preferably a swelling curve, based on properties of the paper and/or conditions of impregnating.

6. The method according to claim 2, wherein the one or more first scaling values are in the range of 0.9 to 1.1, preferably 0.95 to 1.05, more preferably 0.98 to 1.02, more preferably 0.99 to 1.01, more preferably 0.994 to 1.006, more preferably 0.996 to 1.004, most preferably 0.998 to 1.002.

7. The method according to claim 1, wherein the dimensions of the pressing means were selected based on one or more second scaling values, the one or more second scaling values being based at least in part on a thermal expansion of the pressing means during the synchronized embossing process.

8. The method according to claim 7, wherein the one or more second scaling values comprise a length scaling value for the length of the pressing means and width scaling value for the width of the pressing means.

9. The method according to claim 7, wherein the one or more second scaling values are in the range of 0.9 to 1.1, preferably 0.95 to 1.05, more preferably 0.98 to 1.02, more preferably 0.99 to 1.01, more preferably 0.994 to 1.006, more preferably 0.996 to 1.004, most preferably 0.998 to 1.002.

10. The method according to claim 1, wherein the decorative paper is provided by printing the decorative pattern on the paper, preferably by means of digital printing.

11. The method according to claim 1, wherein the decorative pattern is provided by an image retrieved by means of photography or a scanner, preferably by an image from a natural scenery.

12. The method according to claim 1, wherein the decorative pattern imitates a natural pattern, preferably a wooden surface, a stone, a tile, or the like.

13. The method according to claim 1, wherein the decorative pattern provided on the plate has a substantially unique pattern along at least 2 m, preferably at least 3 m, more preferably at least 4 m, more preferably at least 4.5 m, more preferably at least 5.0 m, more preferably at least 5.5 m, most preferably at least 6.0 m of the length of the plate.

14. The method according to claim 1, wherein the carrier plate is a medium density fiber plate, a high-density fiber plate, a particle plate, a compact laminate plate, or a high-pressure laminate plate.

15. The method according to claim 1, wherein the synchronized embossing process takes place at a temperature of at least 100° C., preferably at least 140° C., more preferably at least 180° C., most preferably at least 200° C.; and/or
at a temperature of at most 300° C., preferably at most 260° C., more preferably at most 240° C., most preferably at most 220° C.

16. The method according to claim 1, wherein the synchronized embossing process takes place at a pressure from 20 to 160 bar, preferably from 30 to 140 bar, further preferably from 40 to 120 bar, further preferably from 50 to 100 bar, most preferably from 60 to 90 bar.

17. The method according to claim 1, wherein the synchronized embossing process is a continuously pressed process.

18. The method according to claim 1, wherein the pressing means is a facing press, a press belt, a double-belt press, a rotogravure cylinder, preferably a substantially flat facing press, for providing the plate with an embossed structure on its main surface substantially matching the decorative pattern of the decorative paper.

19. The method according to claim 1, wherein the decorative paper is provided with a thermosetting resins, such as a phenolic resin, a melamine resin, or a formaldehyde resin, preferably a melamine resin.

20. A panel manufactured by a method according to claim 1.

21. The panel according to claim 20, the panel being designed as a wall, ceiling, furniture or flooring panel, comprising coupling elements being configured for coupling to another similar panel.

22. The panel according to claim 20, wherein the panel has a width of at least 8 cm, preferably at least 20 cm, more preferably at least 30 cm, more preferably at least 40 cm, most preferably at least 50 cm,
and/or of at most 260 cm, preferably 210 cm, more preferably at most 200 cm, more preferably at most 180 cm, more preferably at most 140 cm, most preferably at most 100 cm.

23. The panel according to claim 20, wherein the panel has a length of at least 40 cm, preferably at least 50 cm, more preferably at least 60 cm, more preferably at least 80 cm, most preferably at least 100 cm,
and/or of at most 580 cm, preferably at most 560 cm, more preferably at most 500 cm, more preferably at most 450 cm, most preferably at most 400 cm.

24. The panel according to claim 20, wherein the panel has a thickness of at least 4 mm, preferably at least 6 mm, more preferably at least 8 mm, more preferably at least 10 mm, more preferably at least 12 mm, more preferably at least 14 mm, more preferably at least 16 mm, more preferably at least 18 mm, most preferably at least 20 mm,
and/or of at most 50 mm, preferably at most 40 mm, more preferably at most 35 mm, more preferably at most 30 mm, most preferably at most 25 mm.

25. The panel according to claim 20, wherein the printed paper applied on the plate has a thickness of at least 5 μm, preferably at least 10 μm, more preferably at least 20 μm, more preferably at least 30 μm, more preferably at least 40 μm, most preferably at least 50 μm,
and/or of at most 200 μm, preferably at most 150 μm, more preferably at most 100 μm, more preferably at most 90 μm, most preferably at most 80 μm.

26. A system for manufacturing a panel, in particular a wall, ceiling, furniture or flooring panel, the system comprising:
a carrier plate;
a decorative paper with a decorative pattern; and
pressing means having an embossing structure;
wherein the pressing means are configured to perform a synchronized embossing process with the plate and the decorative paper;
wherein the paper with the decorative pattern and/or the pressing means having the embossing structure were made taking into account a dimensional expansion of the decorative paper and/or of the pressing means during the manufacturing of a panel.

27. The method for manufacturing a pressing means for use in a synchronized embossing process according to claim 1, the method comprising the following steps:
providing pressing means having an embossing structure;
wherein the pressing means having the embossing structure are made taking into account a dimensional expansion of a decorative paper and/or of the pressing means during the manufacturing of a panel.
